(19) United States
(12) Patent Application Publication
(10) Pub. No.: US 2014/0191000 A1
(43) Pub. Date: Jul. 10, 2014

(54) CONTAINER FOR LIQUID CHEMICALS

(71) Applicant: Holger Blum, Teufen (CH)

(72) Inventor: Holger Blum, Teufen (CH)

(21) Appl. No.: 14/234,383

(22) PCT Filed: Jul. 20, 2012
(86) PCT No.: PCT/EP2012/064327

§ 371 Date: Mar. 7, 2014

(30) Foreign Application Priority Data
Jul. 22, 2011 (DE) 20 2011 050 795.5

(51) Int. Cl. B65D 1/16; B67D 7/78; B65D 25/38; B65D 1/20; B65D 1/42

(52) U.S. Cl. CPC B65D 1/165; B65D 1/20; B65D 1/42; B65D 25/38; B67D 7/78
USPC 222/464.7; 222/481; 220/605; 220/608

(57) ABSTRACT

A container for liquid chemicals is disclosed, comprising a cylindrical container shell, an upper curved base and a lower curved base, and also a container inflow and a container outflow, wherein the container inflow and the container outflow are arranged at the upper curved base of the container and a drainage tube is provided which extends form the container outflow to the lower curved base.

### BACKGROUND

1. Field

The invention relates to a container for liquid chemicals comprising a cylindrical shell, an upper curved base and a lower curved base as well as a container inflow and a container outflow.

2. Related Art

EP 0 338 573 relates to a safety container for dangerous and/or precious chemical products, in particular in liquid form, in which the container is firmly arranged on a pallet which facilitates handling. In order to provide a container which can be manufactured in a simple way and, if appropriate, is pressure resistant, the container is formed in a cylindrical design and is closed by upper and lower curved bases. In order to achieve the stackability and, if appropriate, the mechanical protection of the container against forces acting from the outside, receiving means for the container are provided at the corner areas of the pallet. In order to fill the container, a cover has to be unscrewed, and emptying of the container takes place at its lower base which complicates the operation and the handling of the container. Furthermore a secure and disturbance-free emptying of the container is not insured in cases where the container is moved. Also the fact that the container has to be mounted on a pallet for its protection complicates the usage of the container.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

The invention is based on the objective to provide a container for liquid chemicals in which the liquid chemicals can securely be transported and from which the liquid chemicals may be taken out in a simple, secure and disturbance-free way also in case the container is not arranged vertically or is moved.

For this purpose, the container for liquid chemicals according to the invention is characterized in that the container inflow and the container outflow are arranged at the upper curved base of the container and in that a drainage tube is provided which extends from the container outflow to the lower curved base. By means of this advantageous embodiment of the container of the invention, a simple and secure operation is insured because the inflow and the outflow to and from the container can be done from its upper side, and because of the fact that the drainage tube reaches to the bottom of the container, a secure emptying of the container is insured also in case the container is not standing up vertically or is moved.

An advantageous embodiment of the container of the invention is characterized in that the container inflow and the container outflow are embodied as inflow stubs and outflow stubs, respectively. The container of the invention is, thereby, arranged in an advantageous way such that the conduits for the inflow and the emptying of the liquid chemicals can be easily connected to the container.

A further advantageous embodiment of the container of the invention is characterized in that a shut-off valve is provided at the container inflow and the container outflow, respectively. Although valves for controlling the inflow and the outflow could be provided in the supply means for the container, it is advantageous when in the container inflow and the container outflow shut-off valves are provided because the operation of the container is possible, in this case, independent of the best preconditions of the filling device or the emptying device.

A further advantageous embodiment of the container of the invention is characterized in that the shut-off valves at the container inflow and the container outflow are glandless valves. Such valves are particularly advantageous in particular if the liquid chemicals are shot-sensitive or friction-sensitive. In such a case, the shut-off valves are not forming any peril points for filling-in and removing the chemicals.

A further advantageous embodiment of the container of the invention is characterized in that, at the lower curved base, a bottom cup curved to the outside is centrally provided, and that the drainage tube reaches into the bottom cup. Since the residual liquid of the chemicals is practically collected in the bottom cup “up to the last drop”, an almost complete removal of the chemical from the container can be insured.

A further advantageous embodiment of the container of the invention is characterized in that the bottom cup is welded to the lower curved base, wherein the bottom cup, in this case, is practically an integral portion of the container which contributes to its stability.

A further advantageous embodiment of the container of the invention is characterized in that the drainage tube extents within the container out of center to the container shell to the area of the bottom of the container and then under an angle to the bottom of the container or the bottom cup. By means of this arrangement, enough space is provided at the upper side of the container in an advantageous way in order to be able to arrange the armatures to be easily accessible and clearly laid out.

A further advantageous embodiment of the container of the invention is characterized in that, on top of the bottom cup a lower bottom cup protective cover is provided which covers the bottom cup. The bottom cup protective cover serves at one hand, the protection of the bottom cup and of the container at its bottom side. On the other hand, the bottom cup protective cover forms a means for anchoring the container in a respectively arranged receptacle, for example a ring, which receives the bottom protective cover, or three or more guiding portions which engage at the bottom cup protective cover when the container is inserted therewith in the anchoring.

A further advantageous embodiment of the container of the invention in characterized in that the bottom cup protective cover is welded to the lower curved base whereby again the stability of the protective cover and also the protection for the container is put up.

A further advantageous embodiment of the container of the invention is characterized in that, around the container shell, an outer shell is provided which surrounds the container shell with a distance. The outer shell serves, in an advantageous way, at first as an additional protection for the container against mechanical influences from outside.

A further advantageous embodiment of the container of the invention is characterized in that the outer shell forms, with the container shell, a closed space which is provided with an inflow stub and an outflow stub. If the space is filled during the transportation with a diluting agent for the chemicals, for example water, a further security measure is provided thereby in case the chemical is leaking out of the container. Furthermore, the closed space can be filled with cooling agent such that a cooling of the chemical in the container during the storage as well as during filling or drainage is ensured.

A further advantageous embodiment of the container of the invention is characterized in that the outer shell is formed in a cylindrical design, is welded, at the upper and the lower side, with tube halves and is welded by means of the tube halves with the container shell. Thereby, a connection free of tensions of the outer shell to the container shell is ensured.

A further advantageous embodiment of the container of the invention is characterized in that the inflow stub is provided at a lower area of the outer shell, and the outflow stub is provided at an upper area of the outer shell. In case the space between the outer shell and the container shell is filled with a liquid, this liquid flows in an advantageous way, from the bottom to the top which allows a uniform filling. If the space is to be drained, the drainage may be done also through the inflow stub at the bottom of the container.

A further advantageous embodiment of the container of the invention is characterized in that an upper protective cover is provided which, in the mounted state, covers the container inflow and the container outflow. This protective cover serves, in an advantageous way, during transportation and storage of the container, for the protection of the armatures which are arranged at the upper side of the container. When the container is put into operation and the armatures have to be accessible, the protective cover can easily be taken off.

A further advantageous embodiment of the container of the invention is characterized in that the upper protective cover is connected to the container by means of a releasable strap connection wherein this is an advantageous and particularly simple solution for taking off the protective cover.

A further advantageous embodiment of the container of the invention is characterized in that a carrying ring is provided on the container wherein the carrying ring is connected to the container by means of fixtures and surrounds the container inflow and the container outflow or the upper protective cover, respectively, with a distance.

The carrying ring again serves for the mechanical protection of the protective cover or the upper side of the container, respectively. On the other hand, the carrying ring forms a simple handling means for the container since the container may be gripped at the carrying ring and, thereafter, be transported. Finely, the carrying ring also serves the purpose to fix the container at a storage site at a wall, a post or the like thereby that a strap is simply put around the carrying ring.

### BRIEF DESCRIPTION OF THE DRAWINGS

Further advantages, features and usage possibilities of the present invention are resulting from the following specification in connection with the embodiments shown in the drawings.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

In the specification, in the claims and in the drawings, the terms as listed in the bellow list of the reference numbers and the respective reference numbers are used. In the drawings:

FIG. 1 shows a vertical section through the container of the invention;

FIG. 2 shows a view on to the upper side of the container of FIG. 1;

FIG. 3 shows a strap connection between the protective cover and the container;

FIG. 4 shows a side view of the container of the invention of FIG. 1, and

FIG. 5 shows a perspective view of the container according to the FIGS. 1 to 4.

### DETAILED DESCRIPTION

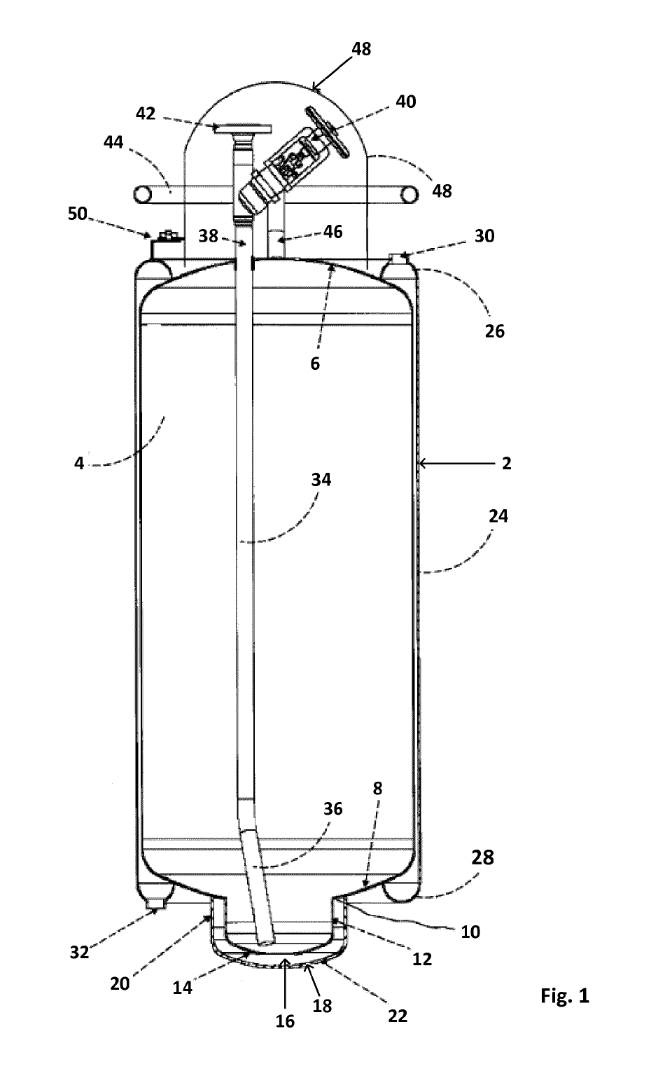

The container 2 of FIG. 1 consists out of metal and comprises a cylindrical shell 4 which is welded at the upper side to a curved top base 6 and to the lower side with a curved bottom or lower base 8.

The lower curved base 8 has a central circular opening 10 into which a further cylindrical shell stub 12 is welded which, itself, is closed by means of a welded, curved bottom 14. The shell stub 12 and the bottom 14 together form a bottom cup 16 in which the remaining of the liquid chemical are collected upon drainage of the container. This arrangement is particularly advantageous when the container 2 is not in a completely vertical position, e.g., tilted, during the drainage procedure.

The bottom cup 16 consisting out of the shell stub 12 and the bottom 14, is protected against a mechanical damage from outside by means of a protective cover 18 which consists out of shell stub 20 welded to the curved base 8 and out of a curved base 22 which is welded to the shell stub 20, thereby forming a protective cover cup 18, which is of larger dimensions and is fitted over cup 16, leaving a protective space in-between.

The cylindrical container shell 4 is protected against outer mechanical damage by means of an outer shell 24. The outer shell 24 is welded to ring tube halves 26 and 28. The ring tube half 26 is welded to upper curved base 6. The ring tube half 28 is welded to the lower curved base 8. By means of the arrangement with the ring tube halves 26 and 28, the outer shell 24 is situated without tension on the container 2.

The ring tube halves 26 and 28 furthermore protect the upper and lower curved bases 6 and 8 against mechanical damage from outside.

A screw socket is welded to the ring tube half 26 as a liquid outflow 30 to which a hose or a tube can be connected. To the ring tube half 28, a screw socket is welded as a liquid inflow 32 to which a hose or a tube may be connected.

The container 2 comprises a drainage conduit 34 out of metal eccentrically to its central axis. At the bottom of the drainage conduit 34, a tube piece 36 is welded in an oblique way. The tube piece 36 reaches almost to the bottom of the curved bottom 14 of the bottom cup 16.

The drainage conduit 34 is hydraulically connected, at its upper side, to the tube stub 38. The tube stub 38 is welded to the upper curved base 6. A valve 40 is welded to the tube stub 38. Preferably, the valve 40 does not comprise a gland but comprises a liquid tight bellows. A tube flange 42 is welded to the valve 40, wherein, in this way, a first armature is formed by which a removable, hydraulic connection of the container 2 to other armatures can be effected.

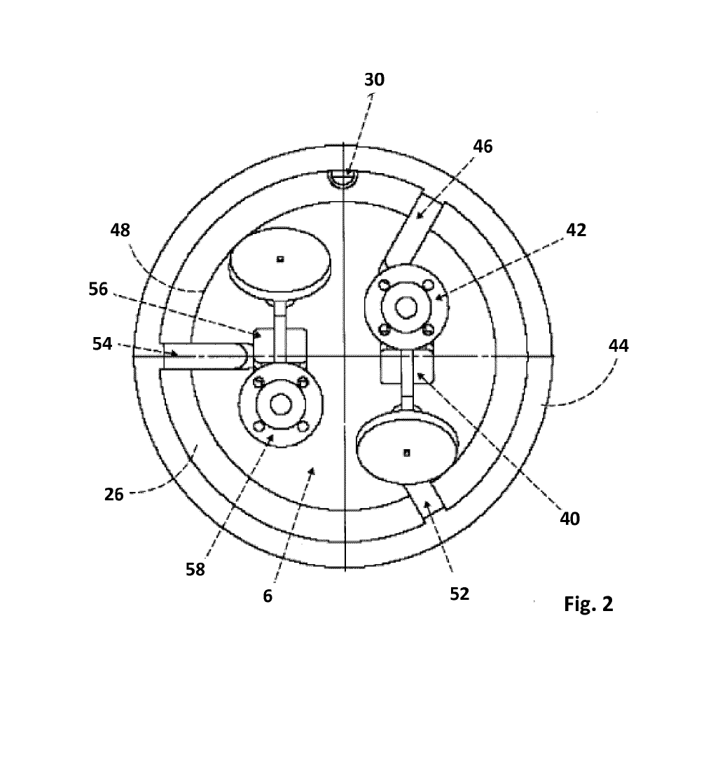

The container 2 comprises a carrying ring 44 which consist out of a circularly bent tube ring the outer diameter of the ring corresponding to the outer diameter of the cylindrical outer shell 24. The carrying ring 44 is connected to the upper curved base 6 by means of at least two mountings. In FIG. 1, a mounting 46 is visible. From FIG. 2, two further mountings as 52 and 54 are visible.

The container 2 comprises, for the protection of the flange stubs and the armatures, an upper protective cover 48 which is connected to the upper ring tube half 26 by means of two removable straps 50. At the side of drainage, the fixing nut 68 of each strap connection is loosened whereby the upper protective cover 48 may easily be removed and the access to the flange 42 is allowed.

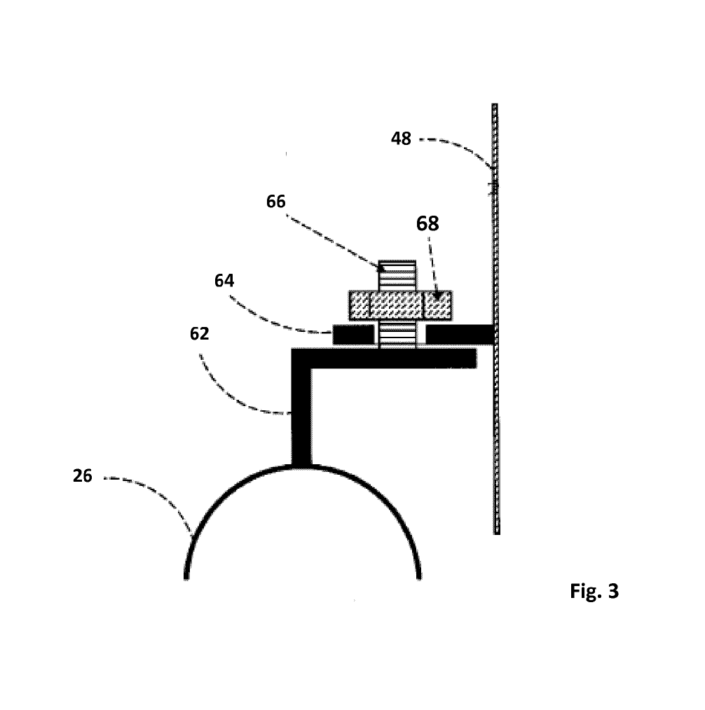

The details of the strap connection 50 can be taken from FIG. 3. Accordingly, the strap connection consists out of a sheet steel angle 62 which is welded to the ring tube half 26 as well as out of an eye 64 which is welded to the outer wall of the upper protective cover 48. During transportation of the container, the steel sheet angle 62 and the eye 64 are fixed to each other by means of the screw stub 66 welded to the steel sheet angle 62 and by means of the fixing nut 68.

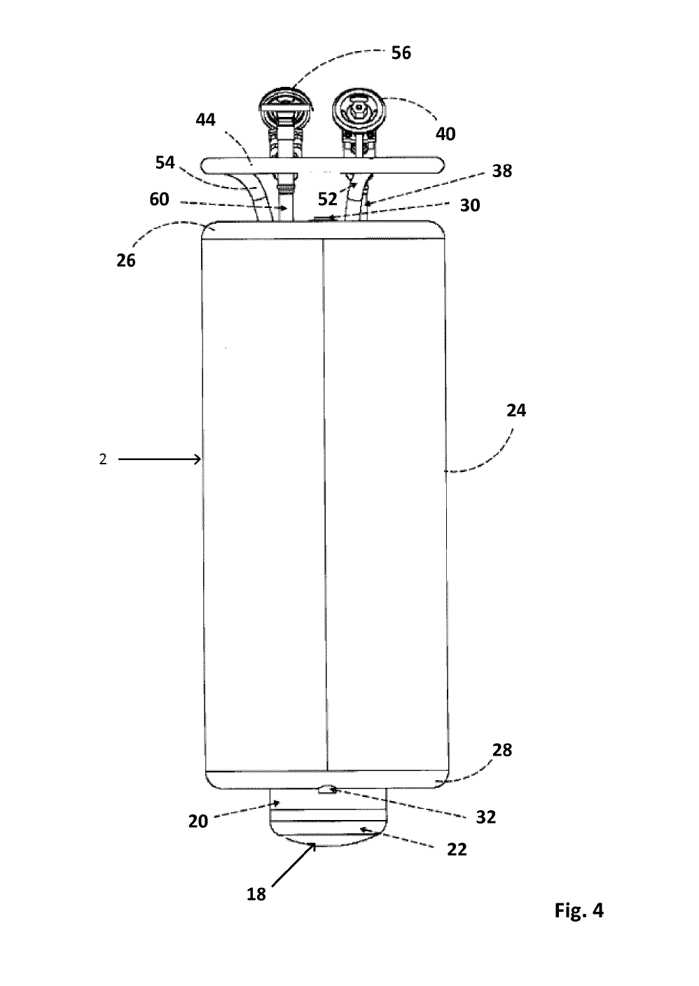

A second armature is arranged at the upper curved base 6 of the container 2 whereby the filling of the container is facilitated. As can be seen from FIG. 4, the armature consists out of a connection flange 58 on to which the valve 56 is welded. The valve 56 is without gland and is arranged as a bellows valve. As can be seen from FIG. 4, the valve 56 is hydraulically connected to the tube stub 60 welded to the upper curved base 6.

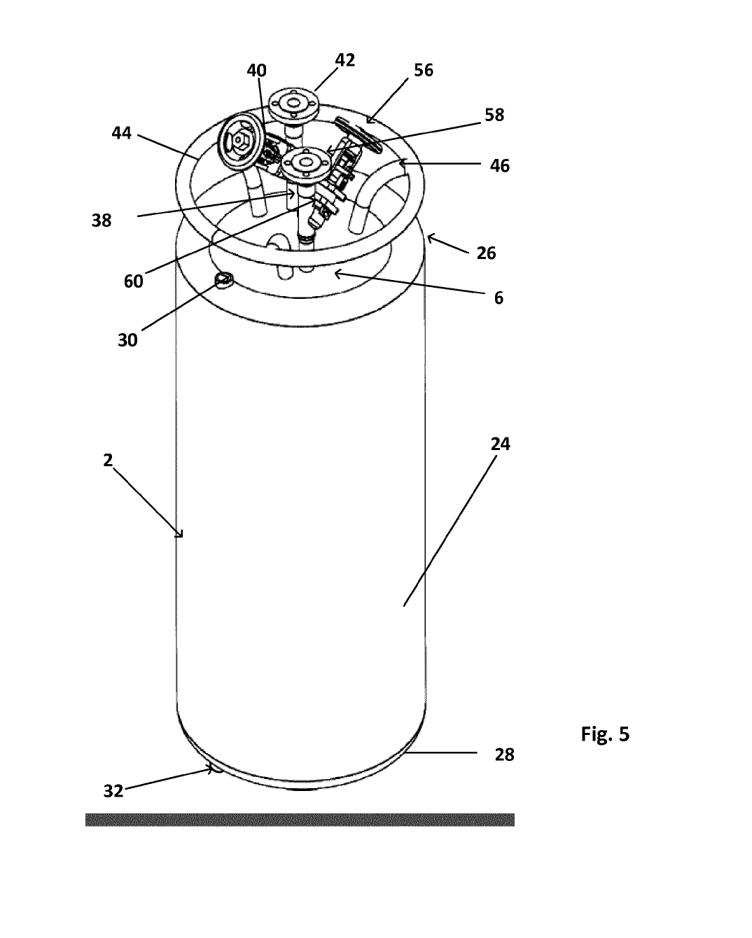

FIG. 5 shows in perspective view the arrangement of the valves 40 and 46 as well as the flanges 42 and 58 at the upper curved base 6 of the container 2.

### LIST OF REFERENCES

2 Container
4 Cylindrical container shell
6 Upper curved base of the container
8 Lower curved base of the container
10 Opening
12 Cylindrical shell of the bottom cup
14 Curved bottom of the bottom cup
16 Bottom cup
18 Protective cover
20 Shell of the lower protective cup
22 Curved bottom of the lower protective cover
24 Cylindrical outer shell
26 Upper ring tube half for the outer shell
28 Lower ring tube half for the outer shell
30 Outflow stub
32 Inflow stub
34 Drainage tube conduit
36 Tube piece
38 Tube stub
40 Valve
42 Flange
44 Carrying ring
46 Holder for carrying ring
48 Upper protective cover
50 Removable strap connection
52 Holder for carrying ring
54 Holder for carrying ring
56 Valve
58 Flange
60 Tube stub
62 Steel sheet angle
64 Eye
66 Screw stub
68 Screw nut

1. Container for liquid chemicals comprising
a cylindrical container shell;
an upper curved base and a lower curved base; and
a container inflow and a container outflow, wherein
the container inflow and the container outflow are arranged at the upper curved base of the container, and wherein
a drainage tube is provided which extends from the container outflow to the lower curved base.

2. Container according to claim 1, wherein the container inflow and the container outflow comprise an inflow tube stub and an outflow tube stub, respectively.

3. Container according to claim 1, wherein at the container inflow and the container outflow a shut off valve each is provided.

4. Container according to claim 3, wherein the shut-off valves, respectively at the container inflow and the container outflow are glandless valves.

5. Container according to claim 1, wherein, at the lower curved base, a bottom cup curved to the outside is provided centrally and that the drainage tube reaches to the bottom cup.

6. Container according to claim 5, wherein the bottom cup is welded to the lower curved base.

7. Container according to claim 1, wherein the the drainage tube is running, in the container, out of the centre to the container shell to the area at the bottom of the container and, than, at an angle to the bottom of the container.

8. Container according to claim 5, wherein, over the bottom cup, a lower bottom cup protective cover is provided which covers the bottom cup.

9. Container according to claim 8, wherein the bottom cup protective cover welded to the lower curved base.

10. Container according to claim 1, wherein, around the container shell, an outer shell is provided which surrounds the container shell with a distance.

11. Container according to claim 10, wherein the outer shell together with the container shell, forms a closed space which is provided with an inflow stub and an outflow stub.

12. Container according to claim 10, wherein the outer shell is formed in a cylindrical design, is welded at the upper side and the lower side with tube halves and is welded with the container shell through the tube halves.

13. Container according to claim 11, wherein the inflow stub is provided at a lower area of the outer shell and the outflow stub is provided at an upper area of the outer shell.

14. Container according to claim 1, wherein an upper protective cover is provided which covers, in the mounted state, the container inflow and the container outflow.

15. Container according to claim 4, wherein the upper protective cover is connected to the container through a removable strap connection.

16. Container according to claim 1, wherein a carrying ring is provided on the container wherein the carrying ring is connected to the container through mountings and surrounds the container inflow and the container outflow or the upper protective cover, respectively, with a distance.

17. Container according to claim 5, characterized in that the drainage tube is running, in the container, out of the centre to the container shell to the area at the bottom of the container and, than, at an angle to the bottom cup.
